(19) United States
(12) Patent Application Publication
(10) Pub. No.: US 2014/0050990 A1
(43) Pub. Date: Feb. 20, 2014

(54) Gel Electrolyte, Preparing Method Thereof, Gel Electrolyte Battery, and Preparing Method Thereof

(71) Applicants: Fang Yuan, Jiangsu Province (CN); Martin William Payne, Independence, OH (US); Xiaodong Wu, Jiangsu Providence (CN)

(72) Inventors: Fang Yuan, Jiangsu Province (CN); Martin William Payne, Independence, OH (US); Xiaodong Wu, Jiangsu Providence (CN)

(21) Appl. No.: 13/641,705

(22) PCT Filed: Feb. 16, 2011
(86) PCT No.: PCT/CN11/00241

§ 371 Date: Sep. 6, 2013

(30) Foreign Application Priority Data
Apr. 20, 2010 (CN) 201010152084.2

(51) Int. Cl. H01M 10/0565; H01M 10/058; H01M 10/0525

(52) U.S. Cl. CPC H01M 10/0565; H01M 10/0525; H01M 10/058
USPC 429/302; 29/623.1

(57) ABSTRACT

A gel electrolyte, a preparing method thereof, a gel electrolyte battery and a preparing method thereof are provided. The gel electrolyte comprises a non-aqueous solvent and a gel constituent, wherein the non-aqueous solvent comprises lithium salt, and the gel constituent comprises polyethylene glycol compounds with unsaturated double bonds, ester monomers with unsaturated double bonds, silane coupling agents and thermal initiators. The preparing method of the gel electrolyte battery includes preparing non-aqueous solvent containing lithium salts; dividing the prepared non-aqueous solvent containing lithium salts into two parts; adding initiators to one part to obtain a gel electrolyte part A; adding monomers and coupling agents to the other part to obtain a gel electrolyte part B; mixing the gel electrolyte part A and the gel electrolyte part B to obtain a gel electrolyte; injecting the obtained gel electrolyte into a dried battery and allowing the battery standing for 16 to 24 hours so as to sufficiently distribute the gel electrolyte inside the battery, and finally in-situ thermally polymerizing the gel electrolyte.

### TECHNICAL FIELD

The application relates to a gel electrolyte, a preparing method thereof, a battery using the gel electrolyte and a preparing method thereof.

### BACKGROUND

Due to higher volumetric specific energy, gravimetric specific energy and excellent environment protection, the lithium ion batteries gradually replace lead-acid batteries, Ni—Cd and MH—Ni batteries and are widely applied to portable electronic equipment, such as mobile phones, notebook computers and the like and have good application prospect. The lithium ion batteries can be divided into liquid state lithium ion batteries and polymer lithium ion batteries according to different electrolytes used by the lithium ion batteries. The liquid state lithium ion battery has excellent high charge-discharge rate and low temperature property, but has the disadvantages that liquid electrolyte is likely to leak, thereby damaging the safety of the battery; in addition, because the outer package of the liquid state lithium ion battery is an aluminum shell or a steel shell, the shape of the battery is limited. Instead of an electrolyte solution, a polymer electrolyte membrane is adopted in the polymer lithium ion battery, the polymer lithium ion battery is packaged by using a composite aluminum plastic film so that the battery can be made into any shape; many micropores are generated by adding plasticizers, pole pieces and diaphragms, compounding and then extracting, and the electrolyte is absorbed through the micropores. However, the method is complex in process and leads to environmental pollution.

A gel electrolyte and a preparing method thereof are provided in Chinese Patents Application No. 03158361.X titled “Lithium Ion Battery Gel Electrolyte Formulation and Methods for Preparing Gel Electrolytic Using Same” and Chinese Patent Application No. 200610122573.7 titled “A Method for Preparing Polymer Gel Electrolyte”. Although the gel electrolyte that can be obtained by using these methods has higher ionic conductivity, electrical property is still poor, and initial voltage and discharge capacity are low.

### DESCRIPTION OF THE INVENTION

Technical problems to be solved by the invention are: aiming at the defects of the prior art, the invention provides a gel electrolyte, a preparing method thereof, a battery using the gel electrolyte and a preparing method thereof The gel electrolyte battery has higher initial voltage and discharge capacity, lower internal resistance and superior electrical property, no-leakage of liquid is ensured, and the safety property of the battery is improved.

The technical schemes of solving the technical problems are as follow:

A gel electrolyte comprises a non-aqueous solvent containing lithium salts and a gel constituent, wherein the gel constituent comprises the following substances: a polyethylene glycol compound with unsaturated double bonds, an ester monomer with an unsaturated double bond, a silane coupling agent and a thermal initiator; the lithium salts in the non-aqueous solvent containing lithium salts are mixed salts; the mixed salts consist of a main salt and an auxiliary salt, wherein the mass percentage of the main salt is 70-100% and the mass percentage of the auxiliary salt is 0-30%; the main salt of the mixed salts is at least one of the following substances: LiPF₆, LiBF₄, LiClO₄, LiI, LiNO₃, LiCF₃SO₃, LiN(CF₃SO₂)₂, LiN(CF₂CF₃SO₂)₂; and the auxiliary salt of the mixed salts is at least one of the following substances: LiB(C₂O₄)₂ or LiBF₂C₂O₄. A secondary lithium battery adopts mixed salts, and a primary lithium battery adopts a single salt.

A preparing method of the gel electrolyte comprises the steps of: firstly, preparing the non-aqueous solvent containing lithium salts and dividing the prepared non-aqueous solvent containing lithium salts into two parts; then, adding the initiator to one part and stirring to be uniform to obtain a gel electrolyte part A for a lithium battery; meanwhile, adding monomers and a coupling agent to the other part; and stirring to be uniform to obtain a gel electrolyte part B for a lithium battery. The obtained gel electrolyte is in a bi-part package, wherein the ratio of the weight percents of the part A and part B is 1:1.

A gel electrolyte battery comprises the above gel electrolyte.

A preparing method of the gel electrolyte battery includes firstly mixing the gel electrolyte part A and the gel electrolyte part B in the weight ratio of 1:1; stirring to obtain an uniform liquid, wherein the viscosity of the liquid is similar to that of the non-aqueous solvent containing lithium salts; injecting the stirred uniform liquid into a dried battery and allowing the battery to stand for 16 to 24 hours so as to sufficiently distribute the gel electrolyte inside the battery, and finally in-situ thermally polymerizing the gel electrolyte to obtain the gel electrolyte battery.

The technical schemes that further define the present invention are as follow:

The weight percent contents of the components in the gel electrolyte are as follows: 0.5-5% of the polyethylene glycol compounds with unsaturated double bonds, 0-10% of the ester monomer with unsaturated double bond, 0-5% of the silane coupling agent, 0.01-2% of the thermal initiators; 80-98% of the non-aqueous solvent containing lithium salts, and the concentration of the lithium salts in the non-aqueous solvent containing lithium salts is 0.5-1.5M.

The polyethylene glycol compound with unsaturated double bonds is a polyethylene glycol di-alkylacrylate compound, which is represented by the following formula: CH₂═C(R)COO(CH₂CH₂O)n-COC(R)═CH₂, wherein n=1-12, and R represents CH₃ or C₂H₅. The weight percent content of the polyethylene glycol compound with unsaturated double bonds is 0.8-3.5%.

The ester monomer with an unsaturated double bond is selected from at least one of the following substances: alkyl (alpha-meth)acrylate, alkyl acrylate. The weight percent content of the ester monomer with an unsaturated double bond is 0.3-8%.

The silane coupling agent is gamma-(methacryloxy)propyltrioxysilane represented by the following formula: CH₂═C(R)—COO(CH₂)n-Si—(OCH₃)₃, wherein n=1-3, and R represents H or CH₃. The weight percent content of the silane coupling agent is 0.5-3%.

The thermal initiator is selected from at least one of the following substances: azodiisobutyronitrile, dibenzoyl peroxide, bis(4-tert-butylcyclohexyl)peroxydicarbonate, dodecanoyl peroxide, di-isopropyl peroxydicarbonate. The weight percent content of the thermal initiator is 0.02-1.5%.

The non-aqueous solvent in the non-aqueous solvent containing lithium salt is selected from at least one of the following substances: ethylene carbonate, propylene carbonate, butylene carbonate, 1,2-dimethyl ethylene carbonate, ethyl butyl carbonate; methyl butyl carbonate, dibutyl carbonate, diethyl carbonate, dimethyl carbonate, trifluoromethyl ethylene carbonate, di-n-propyl carbonate, diisopropyl carbonate, methyl ethyl carbonate, ethyl propyl carbonate, ethyl isopropyl carbonate, methyl propyl carbonate, dimethoxyethane, diethoxyethane, tetrahydrofuran, 2-methyltetrahydrofuran, diethylene glycol dimethyl ether, triethylene glycol dimethyl ether, tetraethylene glycol dimethyl ether, 1,3-dioxolane, dimethyl sulfoxide, sulfolane, 4-methyl-1,3-butyrolactone, gamma-butyrolactone, methyl formate, ethyl formate, methyl acetate, ethyl acetate, methyl propionate, ethyl propionate, methyl butyrate, ethyl butyrate, vinylene carbonate, propane sultone, ethylene sulfite. The concentration of the lithium salts in the non-aqueous solvent containing lithium salt is 0.8M-1.35M. The weight percent content of the non-aqueous solvent containing lithium salt is 88-98 wt %. The lithium salt is selected from at least one of the following substances: LiPF₆, LiBF₄, LiClO₄, wherein the former two (LiPF6 and LiBF4) are common lithium salts for secondary lithium batteries, and the last one (LiClO4) is a common lithium salt for primary lithium batteries.

The in-situ thermal polymerization can be performed in the lithium battery in one step, the polymerization temperature is 50-70° C., and the polymerization time is 16-48 h. The in-situ thermal polymerization can be performed in the lithium battery in several steps employing two-stage temperature profile, namely initiating at high temperature and polymerizing at low temperature, wherein the initiation temperature is 60-90° C., and the polymerization temperature is 40-70° C. The in-situ thermal polymerization can be performed in the lithium battery in several steps employing two-stage temperature profile, namely initiating at high temperature and polymerizing at low temperature, wherein the initiation time is 45-90 min, and the polymerization time is 8-48 h.

The invention has the following advantages: LiB(C₂O₄)₂ or LiBF₂C₂O₄ is introduced as a mixed salt to the gel electrolyte components of the invention, such that the comprehensive electrical property of the electrolyte can be improved and the high and low temperature properties of the battery can be improved. As LiB(C₂O₄)₂ and LiBF₂C₂O₄ have higher heat stability and better cycle property compared with LiPF₆, the property of the secondary lithium battery under high temperature working conditions can be improved.

In the preparing method of the gel electrolyte of the invention, the gel electrolyte is packed into bi-part package. Compared with the single-part package, the bi-part package has the advantages of prolonging the storage life of the gel electrolyte and avoiding failure of the gel electrolyte caused by thermal polymerization of the gel electrolyte in transit.

Compared with the common liquid state electrolyte lithium battery, the present invention has higher initial voltage and discharge capacity, lower internal resistance and superior electrical property. Under the same test conditions, compared with the common liquid state electrolyte lithium battery, the gel polymer battery has slightly higher internal resistance and an initial capacity about 4% lower than that of the common liquid state electrolyte lithium battery, however the initial capacity reaches the design capacity 650 mAh of the battery; after the battery is repeatedly charged and discharged 300 times, the capacity retention rate is 90%, which satisfies the property requirements of the lithium cobaltate secondary battery. Compared with the prior art, the invention adopts a simple preparing method of the gel electrolyte, the safety property of the gel electrolyte battery is improved and good electrochemical property of the lithium battery is guaranteed without changing the preparing process of the gel electrolyte battery or controlling the preparing cost of the gel electrolyte battery. Further details regarding the properties of the gel electrolyte battery of the invention can be seen in Tables 1 and 2.

### EMBODIMENT

### Example 1

The weight percent contents of the components in the gel electrolyte are:
triethylene glycol dimethacrylate: 1.2 wt %
methyl methacrylate: 8 wt %
gamma-(methacryloxy)propyltrioxysilane: 1.2 wt %
azodiisobutyronitrile: 0.06 wt %
azodiisobutyronitrile: 0.06 wt %
non-aqueous solvent containing lithium salts: 0.9M LiPF₆ and 0.1M LiB(C₂O₄)₂, wherein EC/DMC is 3:7, and the weight percentage is 89.54%.

A non-aqueous solvent containing lithium salts is pre-prepared and is divided into two parts; then an initiator azodiisobutyronitrile is added to one part and is stirred to be uniform to obtain a gel electrolyte part A for a lithium battery; meanwhile, the monomers and a coupling agent are added to the other part and are stirred to be uniform to obtain a gel electrolyte part B for a lithium battery; the gel electrolyte part A and the gel electrolyte part B are mixed in the weight ratio of 1:1, wherein mixed liquid is a colorless or light-yellow transparent liquid; after being stirred to be uniform, the mixed liquid is injected into an aluminum-plastic bag for soft bag batteries and the aluminum-plastic bag is sealed. Then an in-situ thermal polymerization is performed; the polymerization temperature at the first section is 85° C., the polymerization time is for 20 min; the polymerization temperature at the second section is 60° C., the polymerization time is for 16 h; a flowing mixed electrolyte forms a stable gel electrolyte. The steps of preparing mixed liquid and injecting liquid are performed in a glove box under the protection of nitrogen, and the in-situ thermal polymerization is performed in a common oven.

Electrochemical properties and physical properties of the formed gel polymer lithium batteries are assessed:

(1) A piece of small (round) gel electrolyte is tightly pressed between two stainless steel inert electrodes to make a simple battery. The frequency response of alternating-current impedance of the simple battery is measured. The analysis on the frequency response shows that the ionic conductivity of the gel electrolyte of example 1 reaches 6.7×10⁻³ S/cm.

(2) The aluminum-plastic bag is opened, the gel electrolyte is taken out and placed between two pieces of sheet glass and is pressed without flowing out liquid state electrolyte.

### Example 2

Each component of the gel electrolyte has following weight percentage:
triethylene glycol dimethacrylate: 3 wt %,
methyl methacrylate: 1 wt %
gamma-(methacryloxy)propyltrioxysilane: 2.5 wt %
Azodiisobutyronitrile: 0.06 wt %
non-aqueous solvent containing lithium salts: 1.0M LiClO4, wherein PC/EMC/DEC is 4:3:3, and the weight percentage is 93.44%. As the battery is the primary battery, the mixed salt is not needed.

The non-aqueous solvent containing lithium salts is pre-prepared and is divided into two parts. Then an initiator of azodiisobutyronitrile is added to one part and stirred to be uniform to obtain a gel electrolyte part A for a lithium battery; meanwhile, the monomers and a coupling agent are added to the other part and stirred to be uniform to obtain a gel electrolyte part B for a lithium battery; the gel electrolyte part A and the gel electrolyte part B are mixed in the weight ratio of 1:1, wherein mixed liquid is colorless or light-yellow transparent liquid; after being stirred to be uniform, the mixed liquid is injected into a lithium/manganese dioxide primary battery to be allowed standing for 12-16 h so as to sufficiently distribute the gel electrolyte inside the battery. Then an in-situ thermal polymerization is performed; the polymerization temperature at the first section is 85° C., the polymerization time is 45-60 min; the polymerization temperature at the second section is 45° C., the polymerization time is 16 h; and a flowing mixed electrolyte forms a stable gel electrolyte. The steps of preparing mixed liquid and injecting liquid are performed in a glove box under the protection of nitrogen, and the in-situ thermal polymerization is performed in a common oven.

Electrochemical properties and physical properties of the formed gel polymer lithium batteries are assessed:

(1) The electrochemical properties of the lithium/manganese dioxide soft bag battery are shown in table 1:

TABLE 1

| | | | | |
|---|---|---|---|---|
| Initial | internal | discharge | Discharge | discharge |
| voltage | resistance | current | capacity | temperature |
| (V) | (Ω) | (mA) | (mAh) | (° C.) |

Control batteries (common liquid state electrolyte lithium batteries)

| | | | | |
|---|---|---|---|---|
| 3.146 | 18.6 | 1 | 9.74 | 20 |
| 3.139 | 18.1 | 0.65 | 10.08 | 20 |
| 3.140 | 17.6 | 0.35 | 10.64 | 20 |
| 3.141 | 16.4 | 0.35 | 0.047 | −20 |

Gel polymer lithium battery

| | | | | |
|---|---|---|---|---|
| 3.227 | 13.4 | 1 | 26.61 | 20 |
| 3.235 | 13.8 | 0.65 | 28.82 | 20 |
| 3.257 | 13.5 | 0.35 | 25.89 | 20 |
| 3.244 | 16.4 | 0.35 | 21.25 | −20 |

The experimental data show that, compared with the common liquid state electrolyte lithium batteries, the gel polymer lithium batteries of the invention have higher initial voltage and discharge capacity, lower internal resistance and superior electrical property under the same testing conditions.

(2) The gel polymer lithium batteries are disassembled, and people visually inspect the overflowing of the electrolyte. The result shows that the gel electrolyte formed in example 2 does not flow out and is in a gel state.

### Example 3

Each component of the gel electrolyte has following weight percentage:
triethylene glycol dimethacrylate: 2.3 wt %,
methyl methacrylate: 0.8 wt %
gamma-(methacryloxy)propyltrioxysilane: 1.9 wt %
azodiisobutyronitrile: 0.05 wt %
non-aqueous solvent containing lithium salts: 0.9M LiPF₆ and 0.1M LiB(C₂O₄)₂, wherein EC/PC/EMC/DMC is 20:8:40:32, and the weight percentage is 94.95%.

The non-aqueous solvent containing lithium salts is pre-prepared and is divided into two parts; an initiator azodiisobutyronitrile is added to one part and stirred to be uniform to obtain a gel electrolyte part A for a lithium battery; meanwhile, the monomers and the coupling agent are added to the other part and stirred to be uniform to obtain a gel electrolyte part B for a lithium battery; the gel electrolyte part A and the gel electrolyte part B are mixed in the weight ratio of 1:1, wherein mixed liquid is a colorless or light-yellow transparent liquid; after being stirred to be uniform, the mixed liquid is injected into a lithium iron phosphate secondary battery to be allowed standing for 12-16 h so as to sufficiently distribute the gel electrolyte inside the battery. Then a in-situ thermal polymerization is performed; the polymerization temperature is 60° C., the polymerization time is for 8-16 h; and a flowing mixed electrolyte forms a stable gel electrolyte. The steps of preparing mixed liquid and injecting liquid are performed in a glove box under the protection of nitrogen, and the in-situ thermal polymerization is performed in a common oven.

Electrochemical properties and physical properties of the formed gel polymer lithium batteries are assessed:

(1)The electrochemical properties of 1,000 mAh lithium iron phosphate cylinder aluminum shell batteries are shown in table 2:

| | | | |
|---|---|---|---|
| Initial | stored capacity | stored capacity | stored battery internal |
| capacity | retention | recovery | resistance change |
| (mAh), | rate (%) | rate (%) | rate (%) |

Control batteries (common liquid state electrolyte
lithium batteries)85° C. @4 hours

| | | | |
|---|---|---|---|
| 1011 | 105.61 | 108.51 | 16.95 |
| 1019 | 105.10 | 107.36 | 17.65 |

Gel polymer batteries (single salt)

| | | | |
|---|---|---|---|
| 1025 | 88.39 | 94.05 | 46.15 |
| 1019 | 89.30 | 94.70 | 47.85 |

Gel polymer batteries (composite salt)

| | | | |
|---|---|---|---|
| 1055 | 95.92 | 98.96 | 30.10 |
| 1077 | 95.54 | 97.96 | 29.17 |

The experimental data show that, compared with the common liquid state electrolyte lithium battery, the gel polymer battery has slightly higher initial capacity under the same test conditions. The capacity retention rate and the capacity recovery rate of the gel polymer battery subjected to high temperature storage are slightly lower than the common liquid state electrolyte lithium battery and are higher than 85%, which satisfies the use requirement of the batteries. The properties of the gel polymer battery of the composite salt are superior to those of the gel polymer battery of the single salt; after the composite salt is utilized, the electrical property of the gel polymer battery is greatly improved. That is to say, the gel polymer electrolyte formed in example 3 can meet the requirement of electrochemical properties of a lithium iron phosphate secondary battery, and guarantee no leakage at the same time and improve the safety property of the battery.

(2) The gel polymer lithium batteries are disassembled, and people visually inspect the overflowing condition of the electrolyte. The result shows that the gel electrolyte formed in example 3 does not flow out and is in a gel state.

The invention can also have other embodiments, and all the technical schemes which adopt equal replacement or equivalent transformation should fall within the scope claimed in the invention.

1. A gel electrolyte, comprising a non-aqueous solvent containing lithium salts and a gel constituent, wherein the gel constituent comprises the following substances: a polyethylene glycol compound with unsaturated double bonds, an ester monomer with an unsaturated double bond, a silane coupling agent and a thermal initiator; characterized in that the lithium salts in the non-aqueous solvent containing lithium salts are mixed salts, in which the mixed salts consist of a main salt and an auxiliary salt, wherein the mass percentage of the main salt is 70-100% and the mass percentage of the auxiliary salt is 0-30%, the main salt of the mixed salts is at least one of the following substances: LiPF₆, LiBF₄, LiClO₄, LiI, LiNO₃, LiCF₃SO₃, LiN(CF₃SO₂)₂ , LiN(CF₂CF₃SO₂)₂, and the auxiliary salt of the mixed salts is at least one of the following substances: LiB(C₂O₄)₂ or LiBF₂C₂O₄.

2. The gel electrolyte of claim 1, characterized in that the weight percentage of each component of the gel electrolyte is:
polyethylene glycol compound with unsaturated double bonds: 0.5-5 wt %
ester monomer with unsaturated double bond: 0-10 wt %
silane coupling agent: 0-5 wt %
thermal initiator: 0.01-2 wt % and
non-aqueous solvent containing lithium salts: 80-98 wt %;
wherein the concentration of the lithium salts in the non-aqueous solvent containing lithium salts is 0.5-1.5M.

3. The gel electrolyte of claim 1, characterized in that the polyethylene glycol compound with unsaturated double bonds is a polyethylene glycol dialkyl acrylate compound, which is represented by the following formula: CH₂═C(R)COO(CH₂CH₂O)n-COC(R)═CH₂, wherein n=1-12, and R represents CH₃ or C₂H₅.

4. The gel electrolyte of claim 3, characterized in that the weight percentage of the polyethylene glycol compound with unsaturated double bonds is 0.8-3.5 wt %.

5. The gel electrolyte of claim 1, characterized in that the ester monomer with unsaturated double bond is selected from at least one of the following substances: alkyl (alpha-methyl) acrylate and alkyl acrylate.

6. The gel electrolyte of claim 5, characterized in that the weight percentage of the ester monomer with unsaturated double bond is 0.3-8 wt %.

7. The gel electrolyte of claim 1, characterized in that the silane coupling agent is gamma-(methacryloxy)propyltrioxysilane represented by the following formula: CH₂═C(R)—COO(CH₂)n-Si—(OCH₃)₃, wherein n=1-3, and R represents H or CH₃.

8. The gel electrolyte of claim 7, characterized in that the weight percentage of the silane coupling agent is 0.5-3 wt %.

9. The gel electrolyte of claim 1, characterized in that the thermal initiator is selected from at least one of the following substances: azodiisobutyronitrile, dibenzoyl peroxide, bis(4-tert-butylcyclohexyl)peroxydicarbonate, dodecanoyl peroxide and di-isopropyl peroxydicarbonate.

10. The gel electrolyte of claim 9, characterized in that the weight percentage of the thermal initiator is 0.02-1.5 wt %.

11. The gel electrolyte of claim 1, characterized in that the non-aqueous solvent in the non-aqueous solvent containing lithium salt is selected from at least one of the following substances: ethylene carbonate, propylene carbonate, butylene carbonate, 1,2-dimethyl ethylene carbonate, ethyl butyl carbonate, methyl butyl carbonate, dibutyl carbonate, diethyl carbonate, dimethyl carbonate, trifluoromethyl ethylene carbonate, di-n-propyl carbonate, diisopropyl carbonate, methyl ethyl carbonate, ethyl propyl carbonate, ethyl isopropyl carbonate, methyl propyl carbonate, dimethoxyethane, diethoxyethane, tetrahydrofuran, 2-methyltetrahydrofuran, diethylene glycol dimethyl ether, triethylene glycol dimethyl ether, tetraethylene glycol dimethyl ether, 1,3-dioxolane, dimethyl sulfoxide, sulfolane, 4-methyl-1,3-butyrolactone, gamma-butyrolactone, methyl formate, ethyl formate, methyl acetate, ethyl acetate, methyl propionate, ethyl propionate, methyl butyrate, ethyl butyrate, vinylene carbonate, propane sultone and ethylene sulfite.

12. The gel electrolyte of claim 11, characterized in that the lithium salt is selected from at least one of the following substances: LiPF₆, LiBF₄ and LiClO₄.

13. The gel electrolyte of claim 11, characterized in that the concentration of the lithium salts in the non-aqueous solvent containing lithium salts is 0.8-1.35M.

14. The gel electrolyte of claim 11, characterized in that the weight percentage of the non-aqueous solvent containing lithium salts is 88-98 wt %.

15. A preparing method of the gel electrolyte of any one of claims 1-14, characterized in that: firstly, preparing the non-aqueous solvent containing lithium salts and dividing it into two parts; then, adding the initiator to one part and stirring to be uniform to obtain a gel electrolyte part A for a lithium battery, meanwhile, adding the monomers and the coupling agent to the other part and stirring to be uniform to obtain a gel electrolyte part B for a lithium battery, wherein the obtained gel electrolyte is packed into bi-part package, wherein the ratio of the weight percents of the part A and part B is 1:1.

16. A battery using a gel electrolyte, characterized in that the battery has the gel electrolyte of any one of claims 1-14.

17. A preparing method of the battery using a gel electrolyte of claim 16, characterized in that: firstly, preparing the non-aqueous solvent containing lithium salts and dividing it into two parts, then adding the initiator to one part and stirring to be uniform to obtain a gel electrolyte part A for a lithium battery, meanwhile, adding the monomers and the coupling agent to the other part and stirring to be uniform to obtain a gel electrolyte part B for a lithium battery, mixing the gel electrolyte part A and the gel electrolyte part B in the weight ratio of 1:1, stirring to obtain an uniform liquid, wherein the viscosity of the liquid is similar to that of the non-aqueous solvent containing lithium salt, then injecting the stirred uniform liquid into a dried battery and allowing the battery to stand for 16 to 24 hours so as to sufficiently distribute the gel electrolyte inside the battery, and finally, obtaining the gel electrolyte battery via in-situ thermal polymerization.

18. The preparing method of the battery using a gel electrolyte of claim 17, characterized in that the in-situ thermal polymerization is performed in the lithium battery in one step, the polymerization temperature is 50-70° C., and the polymerization time is 16-48 h.

19. The preparing method of the battery using a gel electrolyte of claim 17, characterized in that the in-situ thermal polymerization is performed in the lithium battery in several steps employing two-stage temperature profile, namely being initiated at high temperature and polymerizing at low temperature, wherein the initiation temperature is 60-90° C., and the polymerization temperature is 40-70° C.

20. The preparing method of the battery using a gel electrolyte of claim 17, characterized in that the in-situ thermal polymerization is performed in the lithium battery in several steps employing two-stage temperature profile, namely being initiated at high temperature and polymerizing at low temperature, wherein the initiation time is 45-90 min, and the polymerization time is 8-48 h.
